(19) United States
(12) Patent Application Publication
(10) Pub. No.: US 2006/0242011 A1
(43) Pub. Date: Oct. 26, 2006

(54) Method and system for automatic, customer-specific purchasing preferences and patterns of complementary products

(75) Inventors: Kevin H. Bell, Raleigh, NC (US); Nathan Colgate Clark, Castro Valley, CA (US); Boyd King Dimmock, Raleigh, NC (US); John Smith Graham, Raleigh, NC (US); James Louis Griesedieck, Raleigh, NC (US); Ameet Anil Kulkarni, Woburn, MA (US); Krishna Prasad, Cary, NC (US); Thomas John Sluchak, Apex, NC (US)

Correspondence Address: IBM CORPORATION, PO BOX 12195, DEPT YXSA, BLDG 002, RESEARCH TRIANGLE PARK, NC, 27709, US

(73) Assignee: International Business Machines Corporation, Armonk, NY (US)

(21) Appl. No.: 11/111,543

(22) Filed: Apr. 21, 2005

(51) Int. Cl. G06Q 30/00

(52) U.S. Cl. 705/14

(57) ABSTRACT

A method and system that provides for the automatic identification of complementary retail items, based upon a selection of specific characteristics of a consumer's shopping pattern or history, is provided. More particularly, the present invention relates to a method and system that provides for a methodological analysis of selected shopping characteristics in relation to recognition of specific shopping patterns and/or purchased item relationships with customer-specific identified complementary items, and the automated generation and identification of product preferences and purchasing patterns specific to a select consumer. Additionally the present invention is readily used with point of sale (POS) terminals, kiosks and retail-based computer systems.

### BACKGROUND OF THE INVENTION

1. The Field of the Invention

The present invention relates in general to a method and system that provides for identifying purchasing interests, complementary products related to those historically purchased, and purchasing patterns of consumers, preferably in a retail environment. More particularly, the present invention relates to a method and system that provides prompts to a customer to improve the shopping experience.

2. Description of the Related Art

It is widely known that computer systems are used and integrated with most retail related environments. Examples of this include the use of Point of Sale (POS) devices, cash registry and inventory control devices, and various computerized systems in retail environments such as groceries, superstores and department stores. Now, it is becoming more commonplace for consumers to be offered the opportunity to use a self-checkout (SCO) system, which typically comprises many of the characteristics of a POS and a checkout lane with the added benefit of allowing the consumer to conduct the checkout process. Similarly, POS-types of systems are also used at automated teller machine (ATM) locations, fast food locations and kiosks throughout the retail and banking sectors. Other variations of these types of system include those that can use a display technology in combination with smart cards, credit cards or biometric identifiers. These types of systems are referred to hereinafter as POS systems and touch sensitive devices, though such descriptions are intended to be inclusive and instructive to any and all computer systems having a display that is touch-sensitive and/or is used to accommodate the interactive input of instructions from users by hand, finger, eye (or similar biometric basis), pen, stylus, bar code scanner or pointing stick.

FIG. 1 is a depiction of a common touch screen type of device, such as a point of sale terminal. As shown in FIG. 1, one common type of interactive computer system 100 permits an operator to enter information into the computer traditionally via keypad or selectively via touching points on the screen 105 of a computer monitor or display device, such as a Cathode Ray Tube (CRT) or Liquid Crystal Display (LCD), upon which is displayed relevant information.

In operation, though most all of the information that can be input to these POS systems is similar, often times it is the types of data that is collected based upon the transaction that may differ. The difference in the type of data collected may depend on the complexity of the computer system present at the retailer, the interest of the retailer in tracking purchasing information and histories of its clientele, or the ability of the retailer to collect the information efficiently through scanning of barcodes and the like. It is known that there are numerous marketing and information collection entities that are interested in acquiring the purchasing habits and histories of purchasing consumers and using this information to improve sales of manufacturers to retailers, improve targeted marketing efforts to consumers and retailers, and to encourage retailers and consumers to perform certain purchasing activities in view of marketing incentives.

Similarly, discount coupons have long been used in the packaged goods industry to promote the sale of specific items to consumers. Many discount coupons are distributed by mail, or as inserts (known as free standing inserts) in newspapers and magazines. This method of distribution has the major drawback that it is not “targeted” to consumers most likely to use the discount coupons. Consequently, mass distribution of discount coupons is not only wasteful in terms of paper and other costs, but results in a very low rate of redemption of the coupons. Most consumers simply ignore them or, if they use coupons at all, discard them because of lack of interest in the specifically promoted products. Recognizing this inefficiency, certain retailers and marketing programs developed coupon-based program schemes, based on the products purchased by the consumers that would issue alternative product coupons in view of select products then purchased by the consumer. In many instances, a competitor's product would be issued to a consumer based on their purchase of a base product item (i.e., a purchase of soda from Soda Company A would trigger the issuance of a coupon to purchase soda from Soda Company B).

If a consumer purchased a “triggering” product that had been previously selected as part of a promotion, the consumer would receive a discount coupon upon paying for purchased items at a checkout stand. The coupon handed to the consumer typically provides for a discount on a competitive or complementary product when the customer returns to the store on a subsequent visit. Unfortunately this type of incentive often frustrates a consumer who has become interested in a particular branded offering, and the competitor's coupon is not used although the competitor is often charged a marketing fee by the coupon issuing entity or retailer.

It is routine today for the purchase transactions of consumers to be captured in databases at retailers or within retailer networks, and often these transactions (and the associated purchase histories) are captured without the overt knowledge of the consumer every time the consumer uses a shopping or store identification card (e.g. frequent shopper card). Users of these cards are encouraged to use them at the retailer location, where upon their use by the consumer, discounts are passed on to the consumer in their immediate purchase essentially in exchange for the recordation and use of transaction information created, generated, profiled and sold with regard to the consumer.

Of interest is that the information gathered on a consumer and transactions of the consumer may be offered to numerous types of entities, but such information is not known to be offered to the consumer for the consumer's use. Were the consumer able to access this information and assess this information in view of consumer-oriented interests and characteristics (as opposed to marketing entity interest), a consumer or an associate of a consumer would be able to identify likely purchasing needs, purchasing trends and patterns, and the like. Similarly, where a consumer, retailer or product-related entity were to thereafter create and make available an associated complementary product relationship, consumers could also find additional value in their shopping activity by identifying, or having identified for them, complementary product offerings in relation to present and past products purchased, shopping patterns, and consumer or consumer shopping characteristics. However, complementary product relationships are typically driven by retailer or manufacturer-based incentives instead of the complementary relationships preferred and inherently created by the consumer. Preferentially, identifying complementary products purchased by the consumer instead of those promoted by a manufacturer or retail would be directly beneficial to the consumer.

Accordingly, there is a need for improvement in the provision of historical and relational information of a consumer, regarding their transactional activities, to the consumer, and for the generation and identification of purchasing patterns as well as preferential complementary product interests based upon such consumer information.

Therefore, what is needed is a method and system that provides for the automatic identification of consumer-based purchasing patterns and preferential complementary retail items, based upon a selection of specific characteristics of a consumer's shopping pattern or history. More particularly, what is needed is a method and system that provides for the automated generation and identification of product preferences and purchasing patterns specific to a select consumer based on a methodological analysis of selected shopping characteristics of the select consumer in relation to an algorithmic recognition of specific shopping patterns and/or purchased item relationships with customer-specific identified complementary items. Such a method and system should also be readily used with point of sale (POS) terminals, kiosks and retail-based computer systems.

The present invention fulfills this need, as will become apparent from the following summary.

### BRIEF SUMMARY OF THE INVENTION

The present invention has been developed in response to the present state of the art, and in particular, in response to the problems and needs in the art that have not yet been fully solved by currently available retail devices and processes.

Accordingly, it is an overall object of the present invention to provide a method and system that provides for the automatic identification of complementary retail items and purchasing patterns, based upon a selection of specific characteristics of a consumer's shopping pattern or history. It is a further object of the present invention to provide a method and system that provides for the automated generation and identification of product preferences and purchasing patterns specific to a select consumer based on a methodological analysis of selected shopping characteristics of the select consumer in relation to an algorithmic recognition of specific shopping patterns and/or purchased item relationships with predetermined complementary items, using commonly available types of computer-based retail systems such as point of sale (POS) terminals, kiosks and retail-based computer systems, sales transaction recording systems (hereinafter referred to collectively without exclusion as “retail terminal”). Here, complementary items and patterns means not only general complements like chips and dip; but, also, customer unique complements, as may result from a special favorite recipe.

The present invention overcomes many or all of the above-discussed shortcomings in the art. To achieve the foregoing objects, and in accordance with the invention as embodied and broadly described herein in the preferred aspects and embodiments, a retail system and method for automatic generation and identification of purchasing preferences of and complementary product offerings in a shopping list for a consumer in a retail environment in relation to said consumer's historical retail transactions and purchasing patterns at a particular time, is provided. Preferably the present invention is adaptable for a user or (also used herein interchangeably as “consumer”) or retailer to customize to meet unique interests of a user or retailer, respectively.

As used herein, the terms “consumer”, “user”, “purchaser”, “shopper” and the like are intended to be used interchangeably but are not intended to be singular or necessarily specific to one individual, but rather the terms individually and collectively are intended to be singular and plural and may also be used to be inclusive of two or more persons, families of users (related or otherwise), similarly profiled users, and any other combination or collection of purchasers that includes at least one user. As used herein, the terms “retailer”, “manufacturer”, “retail environment”, “seller” and the like are intended to be used interchangeably but are not intended to be singular or necessarily specific to one entity, but rather the terms individually and collectively are intended to be singular and plural and may also be used to be inclusive of two or more retail or manufacturing entities.

In one embodiment of the present invention, a method for automatic generation and identification of purchasing preferences of and complementary product offerings in a shopping list for a consumer in a retail environment in relation to said consumer's historical retail transactions and purchasing patterns at a particular time, for use with at least one retail terminal with access to a transaction retail database having transactional history for said consumer regarding said consumer's historical retail transactions and product purchasing histories, is provided.

In another embodiment of the present invention, a system having at least one point of sale terminal and a retailer database having consumer information, using a method for automatic generation and identification of purchasing preferences of and complementary product offerings in a shopping list for a consumer in a retail environment in relation to said consumer's historical retail transactions and purchasing patterns at a particular time, for use with at least one retail terminal with access to a transaction retail database having transactional history for said consumer regarding said consumer's historical retail transactions and product purchasing histories, is provided.

The method and system as described above allows for a number of advantageous results, including but not limited to: family, friends, or an individual shopper can identify shopping histories and shopping patterns of a consumer and may thereafter conveniently make purchases; consumers may better understand the relationships of items purchased presently and in the past; consumers may receive improved incentive-based marketing from product manufacturers or retailers based upon the knowledge of related shopping interests, specific product relationships, complementary offers, and purchasing patterns.

These and other objects, features, and advantages of the present invention will become more fully apparent from the following description and appended claims, or maybe learned by the practice of the invention as set forth hereinafter. The above is merely a summary of the invention and thus contains, by necessity, simplifications, generalizations and omissions of detail; consequently, those skilled in the art will appreciate that the summary is illustrative only and is not intended to be comprehensive or limiting with regard to the invention at hand.

### BRIEF DESCRIPTION OF THE DRAWINGS

In order to better understand the manner in which the advantages, aspects and objects of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a depiction of a common touch screen type of device, such as a point of sale terminal;

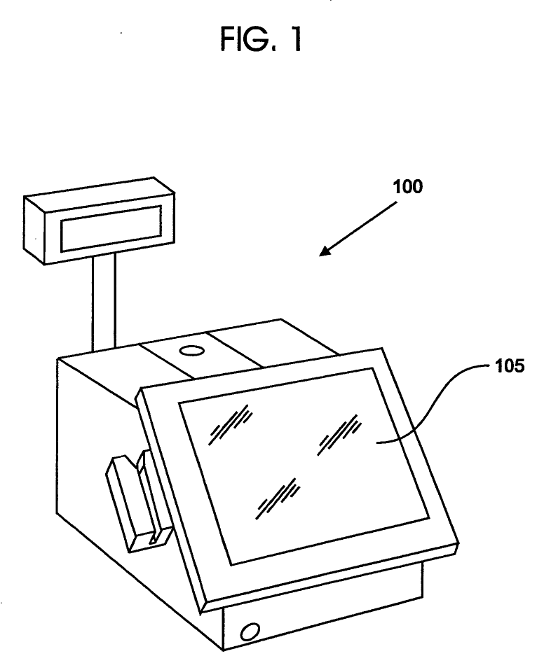

FIG. 2 is a flowchart of a method of the present invention in accordance with a preferred embodiment;

FIG. 3 is a depiction of a preferred kiosk used at many retailers; and,

FIG. 4 is diagram of system in a retail environment of the present invention in accordance with a preferred embodiment.

### DETAILED DESCRIPTION OF THE PREFERRED EMBODIMENTS

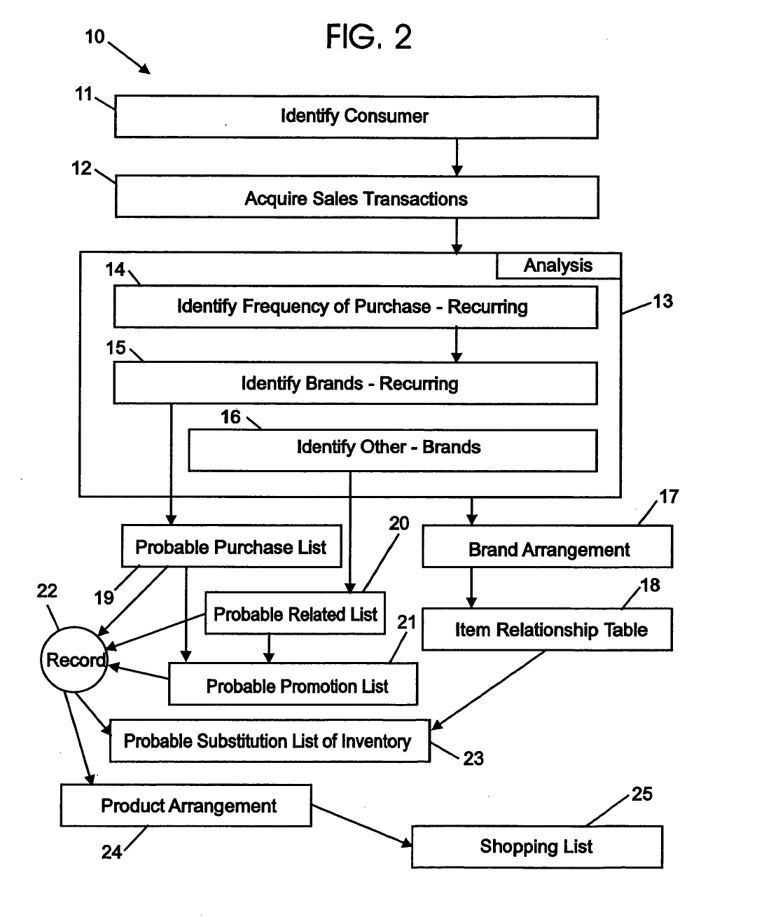

FIG. 2 is a flowchart 10 of a method of the present invention in accordance with a preferred embodiment. The method for automatic generation and identification of purchasing preferences of and complementary product offerings in a shopping list for a consumer in a retail environment in relation to said consumer's historical retail transactions and purchasing patterns at a particular time, for use with at least one retail terminal with access to a transaction retail database having transactional history for said consumer regarding said consumer's historical retail transactions and product purchasing histories is set forth at 10.

For the method 10, at least one consumer for whom a preferential shopping list is to be generated in said retail environment is identified, 11. This identification may take place using a consumer's shopping history card, frequent shopper card, credit card or by the consumer notifying the retailer of a particular uniqueness to the consumer (i.e., name and address, social security number, etc.). One or more sales transactions from a sales transaction database for historical product purchases by said consumer are then acquired, 12.

An analysis of the acquired sales transactions is then performed in relation to the particular time of interest (such as 1 week ago, present time, or a future time using historical data), 13. The analysis comprises a series of steps involving using data in the database including: identifying frequency of purchases of one more recurring products in said sales transactions, 14; identifying specific brand types of one more recurring products in said sales transactions, 15; and identifying one or more products by brand type also purchased by consumer with each identified specific brand types of said one or more recurring products, 16.

Identified data may then be arranged by the identified specific brand types of one or more recurring products in said sales transactions and said brand types of identified of one or more products also purchased by consumer with each identified specific brand types of said one or more recurring products by one or more common product categories, 17. This arrangement is important as it further identifies the branding aspects of purchased products, recurring and non-recurring, of the consumer.

Once the brand arrangement is identified, a consumer item relationship table relating by said one or more common product category said identified specific brand types of one more recurring products in said sales transactions and said brand types of identified one or more products also purchased by consumer with each identified specific brand types of said one or more recurring products is generated, 18. The relationship may be one of time, product type, product brand, frequency of purchase, targeted payment amount or other similar type of defining characteristic. It is envisioned by the present invention that characteristics used to identify products, consumers and purchasing patterns are used in this step, via algorithmic relations, predetermined relations or other targeted interrelationships.

A probable purchase list 19 is then identified based upon said one or more recurring products presently needed by consumer in relation to said particular time as determined from the identification steps of 14 and 15. Brand types of identified one or more products also purchased by consumer with each identified specific brand types of said one or more recurring products from said consumer item relationship table are also identified in a probable related list at 20 in relation to the identification step of 16.

A retailer may then also identify present promotional incentives in said retail environment in relation to said probable purchase list 19 of said one or more recurring products presently needed by consumer and said probable related list 20 of brand types of identified one or more products also purchased by consumer with each identified specific brand types of said one or more recurring products, in a probable promotion list at 21. A retailer may use a variety of characteristics to create an incentive list or triggering events that cause incentive creation. It is envisioned by the present invention that characteristics used to identify products, consumers, purchasing patterns, marketing promotions, advertising promotions, couponing, and the like are used in this step, via one of a variety of generation techniques including but not limited to table look ups, interactive incentivizing, algorithmic relations, predetermined relations or other targeted interrelationships.

The identified promotional incentives are then compared with said acquired sales transactions of said consumer for an instance of a purchase of a brand type (which may be non-recurring) identified in said identified promotional incentive. These additional identified promotional incentives are then included with the prior identified promotional incentives, cumulatively, to said probable promotion list of 21;

Each of the created lists (recording said probable purchase list, said probable related list, and said probable promotion list) are then recorded in relation the identified consumer, preferably but not necessarily in a common database associated with a consumer's history, at 22;

Substitute related products are then further identified at 23 in a substitute products list from a related products database in said retail environment in relation to said probable purchase list, said probable related list, said probable promotion list, present inventory on hand in said retail environment and said item relationship table. In operation, this identification is premised on the availability of inventory data of the retailer that is accurate and current. The identification may be performed directly from the created lists or from the recordation of the lists created. Preferably, the substitute products list is also recorded in relation to the consumer's information.

Identified products set forth in each of the lists (probable purchase list, probable related list, probable promotion list, and substitute products list) are then arranged by their individual location of each product in the retail environment at 24. Preferably, the retailer uses typical product information in relation to its location on shelving and aisles to further set forth for convenience for the consumer the location of items readied for purchase.

A preferential shopping list of identified products for purchase arranged by location of said identified products for purchase in said retail environment comprising products identified in said probable purchase list, said probable related list, said probable promotion list, and said substitute products list is then generated for use by the consumer at 25. Preferably the list is then printed for use by the consumer, but any provision of a list to a consumer is envisioned. For instance, a list could be wirelessly transmitted to a consumer using a smart shopping cart having a point of sale mounted terminal with display thereon.

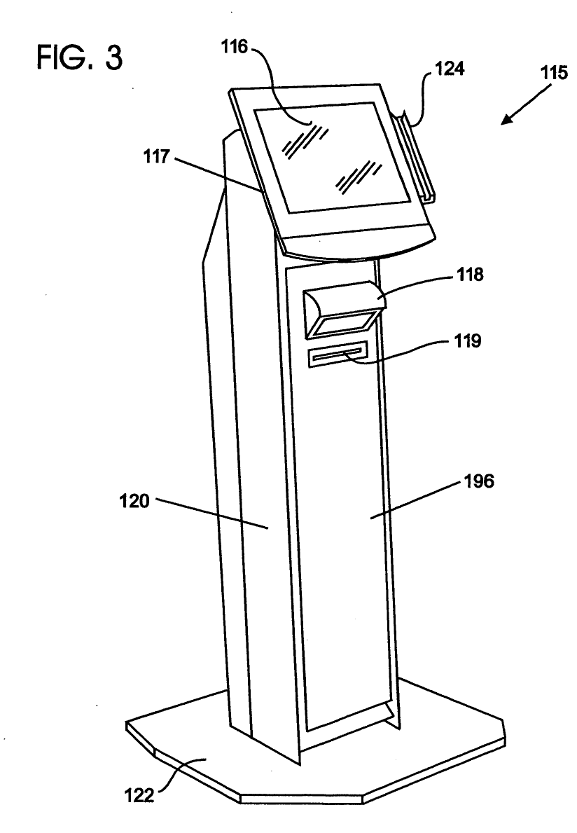

FIG. 3 is a depiction of a preferred kiosk 115 used at many retailers. FIGS. 3 is a depiction of an IBM Kiosk 115 that is of a small footprint 122, is readily serviceable and movable, and is well-suited for consumer interaction. Kiosk 115 comprises an adjustable display 116, a CPU 117, a bar code scanner 118, a card reader 124 and printer device 119, and a tower stand exterior 120.

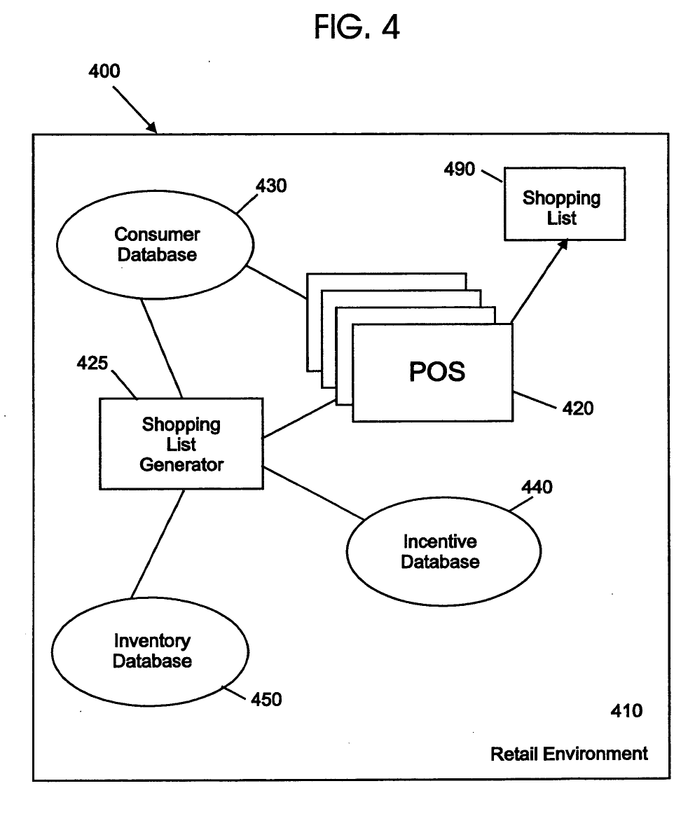

In FIG. 4 is diagram of system in a retail environment of the present invention in accordance with a preferred embodiment 400. A further preferred embodiment, a retail system for automatic generation and identification of purchasing preferences of and complementary product offerings in a shopping list for a consumer in a retail environment 410 in relation to said consumer's historical retail transactions and purchasing patterns at a particular time, comprising at least one retail terminal 420 in said retail environment 410; at least one retail database 430 having transactional history for said consumer regarding said consumer's historical retail transactions and product purchasing histories 430 and the method of the present invention 425, is provided. Preferably, the POS 420 is in communication with the consumer database 430 and is able to trigger the execution of the method of the present invention 425 (as further defined hereinabove previously) to generate a shopping list for the consumer. Preferably, the system 400 also includes an inventory database 450 and an incentive database 440, each of which may be used in conjunction with the method 425 as previously set forth. Preferably the shopping list is generated from a printer located at a POS terminal 490. The list may also be displayed to the customer on a PDA or cell phone or display on a shopping cart(not shown).

In a further preferred embodiment, the generated shopping list sets forth a likely probable value of a need for consumer to purchase an individual product listed therein based upon the frequency of historical purchase and the relationship of purchase to the particular time of interest.

Advantages of the present invention include providing: (1) family, friends, or an individual shopper can identify shopping histories and shopping patterns of a consumer and may thereafter conveniently make purchases; (2) consumers may better understand the relationships of items purchased presently and in the past; and (3) consumers may receive improved incentive-based marketing from product manufacturers or retailers based upon the knowledge of related shopping interests, specific product relationships, complementary offers, and purchasing patterns

The present invention may include customized or off the shelf technology and products without limitation.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for automatic generation and identification of purchasing preferences of and complementary product offerings in a shopping list for a consumer in a retail environment in relation to said consumer's historical retail transactions and purchasing patterns at a particular time, for use with at least one retail terminal with access to a transaction retail database having transactional history for said consumer regarding said consumer's historical retail transactions and product purchasing histories, comprising the steps of:
(a) identifying at least one consumer for whom a preferential shopping list is to be generated in said retail environment;
(b) acquiring one or more sales transactions from a sales transaction database for historical product purchases by said consumer;
(c) analyzing said acquired sales transactions in relation to said particular time by
identifying frequency of purchases of one more recurring products in said sales transactions;
identifying specific brand types of one more recurring products in said sales transactions;
identifying one or more products by brand type also purchased by consumer with each identified specific brand types of said one or more recurring products;
(d) arranging said identified specific brand types of one more recurring products in said sales transactions and said brand types of identified of one or more products also purchased by consumer with each identified specific brand types of said one or more recurring products by one or more common product categories;
(e) generating a consumer item relationship table relating by said one or more common product category said identified specific brand types of one more recurring products in said sales transactions and said brand types of identified one or more products also purchased by consumer with each identified specific brand types of said one or more recurring products;
(f) identifying said one or more recurring products presently needed by consumer in relation to said particular time in probable purchase list;
(g) identifying brand types of identified one or more products also purchased by consumer with each identified specific brand types of said one or more recurring products from said consumer item relationship table in a probable related list;
(h) identifying present promotional incentives in said retail environment in relation to said probable purchase list of said one or more recurring products presently needed by consumer and said probable related list of brand types of identified one or more products also purchased by consumer with each identified specific brand types of said one or more recurring products, in a probable promotion list;
(i) recording said probable purchase list, said probable related list, and said probable promotion list;
(j) further identifying substitute related products in a substitute products list from a related products database in said retail environment in relation to said probable purchase list, said probable related list, said probable promotion list, present inventory on hand in said retail environment and item relationship table;
(k) arranging products in said probable purchase list, said probable related list, said probable promotion list, and said substitute products list by arrangement of location of said products in said retail environment; and,
(l) generating a shopping list of identified products for purchase arranged by location of said identified products for purchase in said retail environment comprising products identified in said probable purchase list, said probable related list, said probable promotion list, and said substitute products list.

2. The method of claim 1 further comprising a plurality of consumers.

3. The method of claim 2 wherein said plurality of consumers are related.

4. The method of claim 3 wherein said item relationship table is further recorded in relation to consumer's information.

5. The method of claim 4 wherein said item relationship table is created based upon product size, product brand and approximate price.

6. The method of claim 4 wherein said item relationship table is created based upon time of day of purchase.

7. The method of claim 4 wherein said item relationship table is created based upon weather information.

8. The method of claim 5 wherein said item relationship table is further created based upon time of day of purchase.

9. The method of claim 1 wherein said shopping list further identifies the relation of each product listed therein to another product where a complementary or incentive relationship exists.

10. The method of claim 1 wherein said shopping list sets forth a likely probable value of a need for consumer to purchase an individual product listed therein.

11. A retail system for automatic generation and identification of purchasing preferences of and complementary product offerings in a shopping list for a consumer in a retail environment in relation to said consumer's historical retail transactions and purchasing patterns at a particular time, comprising: at least one retail terminal in said retail environment; at least one retail database having transactional history for said consumer regarding said consumer's historical retail transactions and product purchasing histories; and a method comprising the steps of:
(a) identifying at least one consumer for whom a preferential shopping list is to be generated in said retail environment;
(b) acquiring one or more sales transactions from a sales transaction database for historical product purchases by said consumer;
(c) analyzing said acquired sales transactions in relation to said particular time by identifying frequency of purchases of one more recurring products in said sales transactions;
identifying specific brand types of one more recurring products in said sales transactions;
identifying one or more products by brand type also purchased by consumer with each identified specific brand types of said one or more recurring products;
(d) arranging said identified specific brand types of one more recurring products in said sales transactions and said brand types of identified of one or more products also purchased by consumer with each identified specific brand types of said one or more recurring products by one or more common product categories;
(e) generating a consumer item relationship table relating by said one or more common product category said identified specific brand types of one more recurring products in said sales transactions and said brand types of identified one or more products also purchased by consumer with each identified specific brand types of said one or more recurring products;
(f) identifying said one or more recurring products presently needed by consumer in relation to said particular time in probable purchase list;
(g) identifying brand types of identified one or more products also purchased by consumer with each identified specific brand types of said one or more recurring products from said consumer item relationship table in a probable related list;
(h) identifying present promotional incentives in said retail environment in relation to said probable purchase list of said one or more recurring products presently needed by consumer and said probable related list of brand types of identified one or more products also purchased by consumer with each identified specific brand types of said one or more recurring products, in a probable promotion list;
(i) recording said probable purchase list, said probable related list, and said probable promotion list;
(j) further identifying substitute related products in a substitute products list from a related products database in said retail environment in relation to said probable purchase list, said probable related list, said probable promotion list, present inventory on hand in said retail environment and item relationship table;
(k) arranging products in said probable purchase list, said probable related list, said probable promotion list, and said substitute products list by arrangement of location of said products in said retail environment; and,
(l) generating a shopping list of identified products for purchase arranged by location of said identified products for purchase in said retail environment comprising products identified in said probable purchase list, said probable related list, said probable promotion list, and said substitute products list.

12. The system of claim 11 further comprising a plurality of consumers.

13. The system of claim 12 wherein said plurality of consumers are related.

14. The system of claim 13 wherein said item relationship table is further recorded in relation to consumer's information.

15. The system of claim 14 wherein said item relationship table is created based upon product size, product brand and approximate price.

16. The system of claim 14 wherein said item relationship table is created based upon time of day of purchase.

17. The system of claim 14 wherein said item relationship table is created based upon weather information.

18. The system of claim 15 wherein said item relationship table is further created based upon time of day of purchase.

19. The system of claim 11 wherein said shopping list further identifies the relation of each product listed therein to another product where a complementary or incentive relationship exists.

20. The system of claim 11 wherein said shopping list sets forth a likely probable value of a need for consumer to purchase an individual product listed therein.
